(19) United States
(12) Patent Application Publication
(10) Pub. No.: US 2015/0368886 A1
(43) Pub. Date: Dec. 24, 2015

(54) Water-Saving Mixer Tap

(71) Applicant: Claude WAUDOIT, Latour (BE)

(72) Inventor: Claude Waudoit, Latour (BE)

(21) Appl. No.: 14/410,599

(22) PCT Filed: Jun. 12, 2013
(86) PCT No.: PCT/EP2013/062160

§ 371 Date: Dec. 23, 2014

(30) Foreign Application Priority Data
Jun. 27, 2012 (LU) 92034

(51) Int. Cl. E03C 1/04; G05D 23/13; E03B 7/04

(52) U.S. Cl. CPC E03C 1/0403; E03B 7/045; G05D 23/1313; E03C 2001/026

(57) ABSTRACT

The invention concerns a water-saving mixer tap with a first water inlet, a second inlet for thermally conditioned water, such as a hot water inlet, at least one service water outlet for water coming from the first water inlet, from the second water inlet or from both, and remarkable in that it further comprises an auxiliary water outlet, and means for interconnection between the conditioned water inlet and the auxiliary outlet with a view to preparing conditioned water without losing water via the service outlet. The invention also concerns a flowing water system comprising such a mixer tap. The auxiliary outlet of the tap is connected to an auxiliary pipe provided with means for storing and/or means for discharging the water from the pipe for water which has lost the conditioning of same and flows towards the auxiliary pipe when the tap is in the position for preparing conditioned water.

### CROSS-REFERENCE TO RELATED APPLICATIONS

The present invention is the US national stage under 35 U.S.C. §371 of International Application No. PCT/EP2013/062160, which was filed on Jun. 12, 2013, and which claims the priority of application LU 92034 filed on Jun. 27, 2012 the content of which (text, drawings and claims) are incorporated here by reference in its entirety.

### FIELD

The invention relates to a water mixing tap able to provide its user with thermally conditioned water such as hot water without in so-doing wasting the water from the hot-water pipe which has cooled and which has to be run off in order to obtain hot water. The invention also relates to a water-mixing tap for hot countries, able to provide its user with chilled water without in so-doing wasting the water in the chilled-water pipe which has warmed up and which has to be run off in order to obtain water that is actually chilled.

The invention also relates to a running-water network comprising a water-saving mixer tap.

### BACKGROUND

In a running-water network comprising hot-water pipes, the source of hot water (water heater, hot water storage tank, etc.) may be a considerable distance away from the draw-off points. When all the draw-off points are closed, the water contained in these hot-water pipes naturally cools. For this reason, when there is next a fresh demand for hot water, it is normally necessary to let the water initially contained in these pipes run in order to reach the desired water temperature at the draw-off point. This is a significant source of water wastage.

Patent document WO 2011/009915 A1 discloses a water-saving mixer tap and a running-water network arrangement in which the cold water contained in the hot-water pipe can be forced back to a tank via the cold-water pipe which is kept at a lower pressure than the hot-water pipe. The mixing tap comprises a position of interconnecting the hot-water inlet with the cold-water inlet.

Patent document CA 2 252 350 A1 also tackles the problem of water wastage when the heat source or source of hot water is distant from the drawing-off point of the distribution network. To do that, this teaching provides a tank for the storage of cooled hot water and two valves. One of the two valves controls the inlet of water from the hot-water pipe and the other controls the inlet of cold water from the tank outlet. A thermostatic device is positioned downstream of the first valve and an auxiliary pipe is connected to the hot-water pipe, between the first valve and the thermostatic device, and to the tank. When the first valve is open, water from the hot-water pipe which has meanwhile cooled is prevented from flowing to the outlet point by the thermostatic device and thus flows via the auxiliary pipe to the tank. When the water temperature reaches a threshold value, the thermostatic device opens and the water which has become hot can then flow to the outlet point. The water that was initially hot and has cooled and which has been diverted to the tank will be able to be used as cold water via the second valve. This teaching also discloses a second embodiment of a distribution network with a mixer tap. The latter comprises a link pipe linking to the auxiliary pipe, the link pipe comprising a valve device collaborating with a thermostatic device positioned in the auxiliary pipe. This device is advantageous in terms of its general principle and the object it seeks to achieve. However, it does require the use of a certain number of components and of connections via pipes, making the solution difficult to apply from a commercial standpoint.

### SUMMARY

It is an objective of the invention to improve the preparation of domestic hot water when drawing off some distance from a source of hot water, notably by making same quicker and more economical.

A subject of the invention is a water-saving mixer tap with: a first water inlet; a second, thermally-conditioned water, inlet; at least one service-water outlet for water coming from the first water inlet, from the second water inlet, or from both and notable in that it further comprises an auxiliary water outlet; means of interconnection between the second water inlet and the auxiliary outlet with a view to preparing conditioned water without loss of water via the service outlet.

The thermal conditioning of the water can be a heating or a chilling of the water. In the former instance, the first inlet can then be a cold, i.e. unconditioned, water inlet or alternatively a chilled-water inlet. In the latter instance, the first inlet can then be an unconditioned-water inlet or alternatively a hot-water inlet.

According to various embodiments of the invention, the tap comprises a flow regulating valve including the interconnection means.

According to various embodiments of the invention, the flow regulating valve is configured also to meter the mixture of water from the first and second water inlets.

According to various embodiments of the invention, the flow regulating valve is configured to close the service outlet when it is in the position of interconnecting the conditioned-water inlet with the auxiliary outlet.

According to various embodiments of the invention, the flow regulating valve comprises a fixed disk with a first orifice connected to the first water inlet, a second orifice connected to the second water inlet, a third orifice connected to the auxiliary outlet and a fourth orifice connected to the service outlet, and a mobile disk able to move against the fixed disk, with a first cavity able to cover at least partially and to interconnect the second and third orifices.

According to various embodiments of the invention, the first, second and third orifices of the fixed disk are arranged in that order along a curved profile, for example essentially in an arc of a circle with respect to the center of the disk.

According to various embodiments of the invention, the first cavity of the mobile disk comprises one or two orifices of curved oblong shape able to collaborate with the second and third orifices of the fixed disk.

According to various embodiments of the invention, the tap comprises means preventing the mobile disk from adopting a position in which its first cavity covers the first orifice, the means in various embodiments being blocking means at the level of a control device controlling the mobile disk.

According to various embodiments of the invention, the mobile disk comprises a second cavity covering the fourth orifice and able selectively to cover at least partially and connect to it the first and/or the second orifice in a service position, the cavity in various embodiments comprising a portion able at least partially to cover and to connect to it the third orifice when it is in a service position, in various embodiments in a position in which it connects the first and second orifice with the fourth.

According to various embodiments of the invention, the portion of the second cavity of the mobile disk forms a protrusion from the generally rounded main part thereof, the protrusion in various embodiments being configured to extend between the second and third orifices without covering them when the mobile disk is in the position of predominantly, in various embodiments exclusively, interconnecting the first and fourth orifices.

According to various embodiments of the invention, the third orifice of the fixed disk and the second cavity of the mobile disk are configured so that the second cavity is not in communication with the third orifice when the mobile disk is in the position essentially, and in various embodiments exclusively, of interconnecting the second and fourth orifices, the third orifice having a curved oblong contour of which the portion facing the contour of the fourth orifice is inclined in such a way as to reduce the width of the third orifice in the direction of the second orifice.

According to various embodiments of the invention, the first cavity of the mobile disk comprises means, in various embodiments thermostatic means, able to move the disk toward a position of stopping the interconnection of the second and third orifices when the temperature in the cavity reaches a threshold value.

According to various embodiments of the invention, the tap comprises thermostatic means of mixing water from the first and second water inlets with a mixed-water outlet and which are separate from the flow regulating valve, the valve comprising a fixed disk with a first orifice connected to the mixed-water outlet of the thermostatic means, a second orifice connected to the second water inlet, a third orifice connected to the auxiliary outlet and a fourth orifice connected to the service outlet, and a mobile disk able to move against the fixed disk, with a cavity able at least partially to cover and to interconnect the first, second and third orifices.

According to various embodiments of the invention, the first orifice of the fixed disk is in a central position of the disk with respect to the other orifices, the second and third orifices being on the opposite side of the first orifice to the fourth orifice.

According to various embodiments of the invention, the fourth orifice is of oblong shape essentially in an arc of a circle centered on the first orifice.

According to various embodiments of the invention, the second and/or the third orifice(s) is/are of oblong shape essentially along an arc of a circle centered on the first orifice.

According to various embodiments of the invention, the cavity of the mobile disk comprises means, in various embodiments thermostatic means, able to move the disk toward a position of stopping the interconnection of the second and third orifices when the temperature in the cavity reaches a threshold value.

According to various embodiments of the invention, the auxiliary outlet comprises means of connection to a pipe and is in various embodiments situated on a portion of the tap that is intended to be hidden.

Another subject of the invention is a running-water network, comprising a first water pipe, means of thermally conditioning the water forming a second water pipe, a water mixing tap with a first inlet connected to the first water pipe, a second inlet connected to the second water pipe; notable in that the tap is in accordance with the invention and in that the auxiliary outlet of the tap is connected to an auxiliary pipe provided with first storage means for storing water from the second water pipe which has lost its conditioning and is flowing toward the auxiliary pipe when the tap is in a position of preparing conditioned water.

The thermal-conditioning means can be means of heating the water or means of cooling or chilling the water. The first pipe is in various embodiments a pipe for water that is not thermally conditioned, i.e. for water referred to as cold water or alternatively as temperate water (in the case of hot countries).

According to various embodiments of the invention, the network comprises second water storage means and a nonreturn valve which are positioned between the conditioning means and the first water pipe, as well as a pump connecting the auxiliary pipe to the first water pipe between the second storage means and the nonreturn valve.

According to various embodiments of the invention, the storage means of the auxiliary pipe comprise a tank fitted with an elastic membrane.

The provisions of the invention make it possible to produce points for drawing off hot or chilled water from a source of hot or chilled water, respectively, some distance from the point, that allow thermally conditioned water to be obtained very rapidly without wasting water. Specifically, the fact of providing an auxiliary outlet on the tap and of connecting it to a dedicated auxiliary pipe allows the water that was initially conditioned but has lost its conditioning to be run off at a higher flow rate therefore making conditioned water available more quickly. Specifically, the auxiliary pipe can operate at a pressure significantly lower than that of the running-water supply network, typically at pressures of below 3 bar, in various embodiments 2 bar, in various other embodiments 1.5 bar, in various other embodiments, 1 bar. The response time is thus shortened without in so-doing wasting water.

In addition, these provisions avoid the need to provide a pressure reducer on the mains water pipe.

### DRAWINGS

FIG. 1 is a diagram of a running-water distribution network according to various embodiments of the invention.

FIG. 2 is a view in section of the tap of FIG. 1, according to various embodiments of the invention.

FIG. 3 is a perspective view of the two disks of the flow regulating valve of the tap of FIGS. 1 and 2, according to various embodiments of the invention.

FIG. 4 is a face-on view of the two disks of FIG. 3 when the flow regulating valve is in the closed position not preparing hot water, according to various embodiments of the invention.

FIG. 5 is a face-on view of the two disks of FIGS. 3 and 4 when the flow regulating valve is in the closed position with hot water being prepared, according to various embodiments of the invention.

FIG. 6 is a face-on view of the two disks of FIGS. 3 to 5, when the flow regulating valve is in the open position, according to various embodiments of the invention.

FIG. 7 is a diagram of the running-water distribution network according to a second embodiment of the invention, according to various embodiments of the invention.

FIG. 8 is a perspective view of the two disks of the flow regulating valve of the tap of FIG. 7, according to various embodiments of the invention.

FIG. 9 is a face-on view of the two disks of FIG. 8 when the flow regulating valve is in the closed position not preparing hot water, according to various embodiments of the invention.

FIG. 10 is a face-on view of the two disks of FIGS. 8 and 9 when the flow regulating valve is in the closed position with hot water being prepared, according to various embodiments of the invention.

FIG. 11 is a face-on view of the two disks of FIGS. 8 to 10, when the flow regulating valve is in the open position, according to various embodiments of the invention.

FIG. 12 is a face-on view of the two disks of FIGS. 8 to 11 when the flow regulating valve is in the open position only with hot water, according to various embodiments of the invention.

FIG. 13 is a face-on view of the two disks of FIGS. 8 to 12 when the flow regulating valve is in the open position only with cold water, according to various embodiments of the invention.

FIG. 14 is a diagram of the running-water distribution network according to a third embodiment of the invention, according to various embodiments of the invention.

FIG. 15 is a perspective view of the two disks of the flow regulating valve of the tap of FIG. 14, according to various embodiments of the invention.

FIG. 16 is a face-on view of the two disks of FIG. 15 when the flow regulating valve is in the closed position not preparing hot water, according to various embodiments of the invention.

FIG. 17 is a face-on view of the two disks of FIGS. 15 and 16 when the flow regulating valve is in the closed position with hot water being prepared, according to various embodiments of the invention.

FIG. 18 is a face-on view of the two disks of FIGS. 15 to 17, when the flow regulating valve is in the open position, according to various embodiments of the invention.

### DETAILED DESCRIPTION

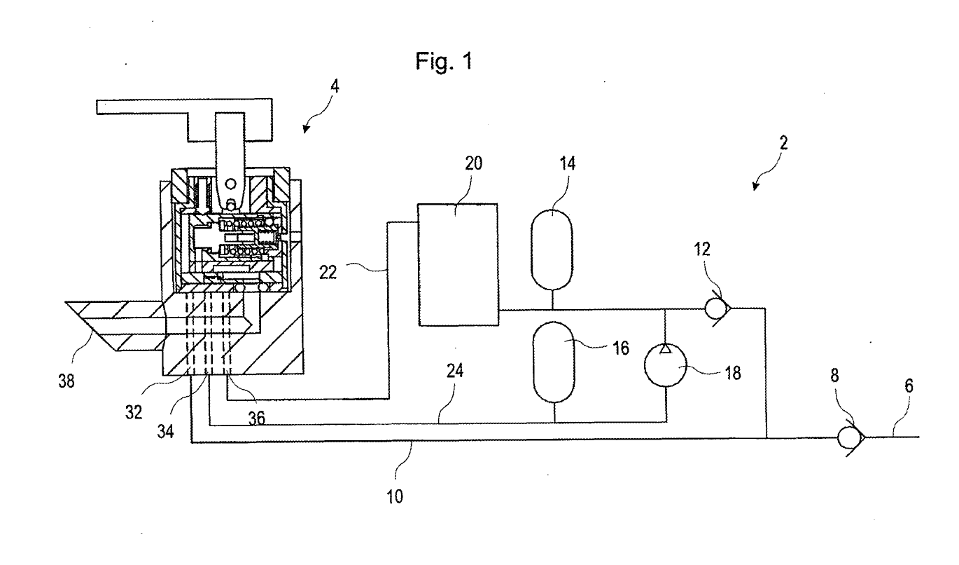

FIG. 1 shows an example of a diagram for the connection of the rapid-action water-saving mixer tap according to a first embodiment of the invention. This connection diagram is in various embodiments intended for a new sanitary installation or when the installation of an additional pipe for the chilled water is possible or already exists. A source of cold water such as a connection to the running-water mains distribution network 6 in various embodiments passes via a nonreturn valve 8, to form the cold-water inlet 10 which is connected directly to a first orifice or first inlet 32 of the mixer tap 4. The cold water inlet 10 is connected, in various embodiments also via a nonreturn valve 12, to a water-heating device 20. The incoming hot water 22 arriving from the water-heating device 20 is connected to a second orifice or second inlet 36 of the mixer 4. The mixer 4 comprises an auxiliary outlet 34 connected via an auxiliary pipe 24 to the suction orifice of an automatic pump 18. The outlet of the automatic pump 18 is connected to the inlet of the water heating device 20. An expansion vessel 14 can be mounted on the inlet pipe of the water heating device 20 to compensate for variations in volume of the water as it is heated. An expansion vessel 16 is also in various embodiments connected to the auxiliary pipe 24 in order to optimize the size of the automatic pump 18.

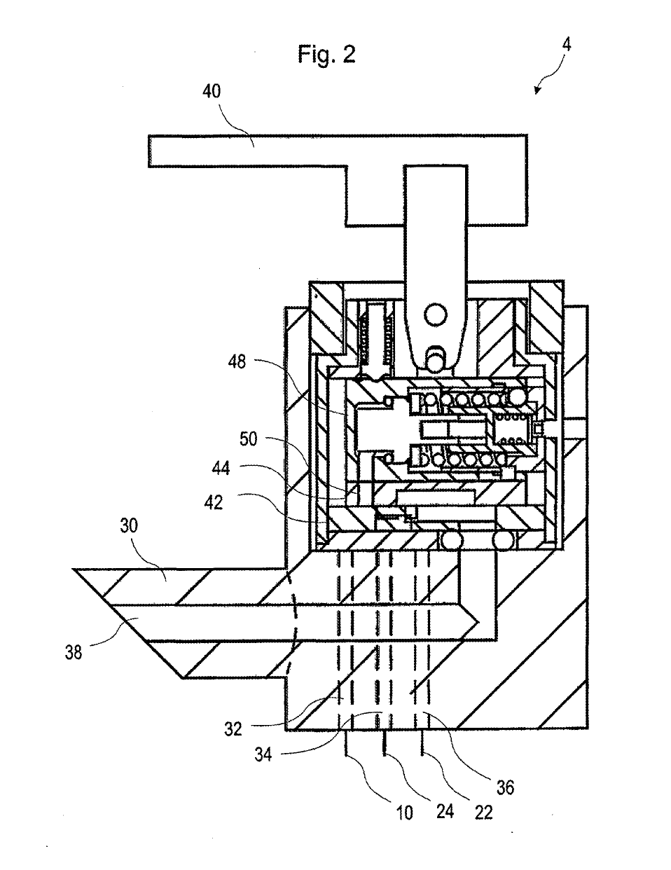

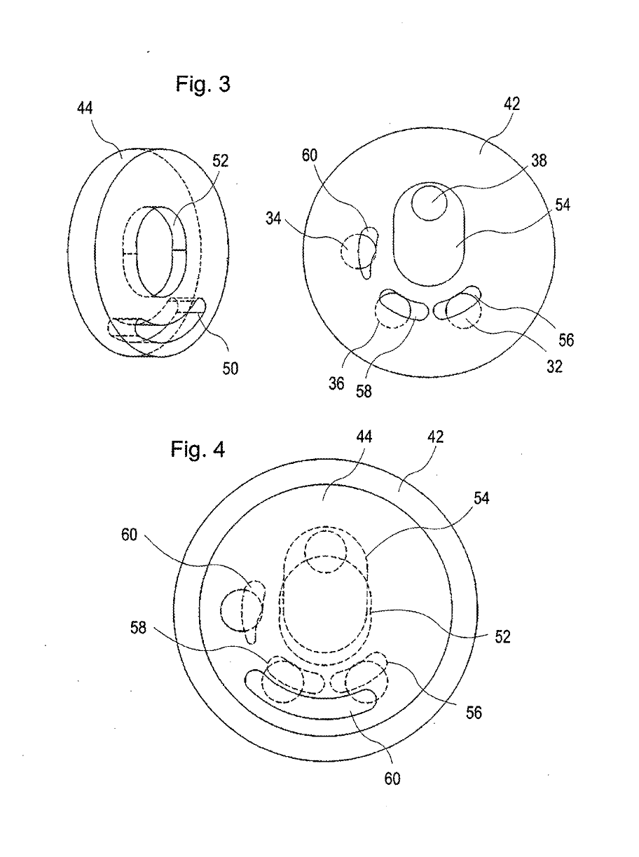

FIG. 2 illustrates the tap 4 of FIG. 1 in greater detail. It is in a neutral position referred to as the position that shuts off the service flow, without connecting the incoming hot water and cold water. It comprises a fixed disk 42 with four orifices that are not visible in FIG. 2. These orifices are connected to the cold water inlet 32 and hot water inlet 36, to the auxiliary water outlet 34 and to the service water outlet 38. These orifices are visible in FIGS. 3 to 6 and will be detailed in relation to the description of these figures. The mobile disk 44 is able to move translationally and rotationally on the fixed disk 42, doing so in a fluidtight manner. Its movement is controlled by the control lever 40 via a mechanism visible in FIG. 2. The mobile disk 44 comprises a support 48 mounted in fluidtight manner on the disk. This support contains thermostatic means able to control the movement of the mobile disk 44. The latter comprises a first cavity 50 formed by a through-orifice shown in greater detail in FIGS. 3 to 6 and allowing hot water to pass directly to the auxiliary pipe 24 while maintaining contact with the thermostatic element in the corresponding cavity of the support 48. The direct passage of the hot water to the auxiliary pipe 24 provided by the cavity 50 makes it possible to reduce the time needed to prepare hot water to an extent such that the user will have access to hot water more quickly by actuating the hot-water preparation mode than by letting the water run into the sink, this being a further advantage and encouraging the user to accord preference to the hot-water preparation function which saves water.

The compression spring fitted between the thermostatic element and the plunger in the support 48 is capable on its own of driving the mobile disk 44, its support 48 and the control lever 40 back toward the closed position of the mixer which is the position illustrated in FIG. 2. The plunger is limited in its movement by a stop which slides in a groove of the support 48 of the mobile disk 44. The plunger is locked and unlocked in the support 48 of the mobile disk as a result of the radial position of one or more balls which slide freely in the radial orifices of the plunger and press against the exterior profile of a piston which slides freely in the plunger.

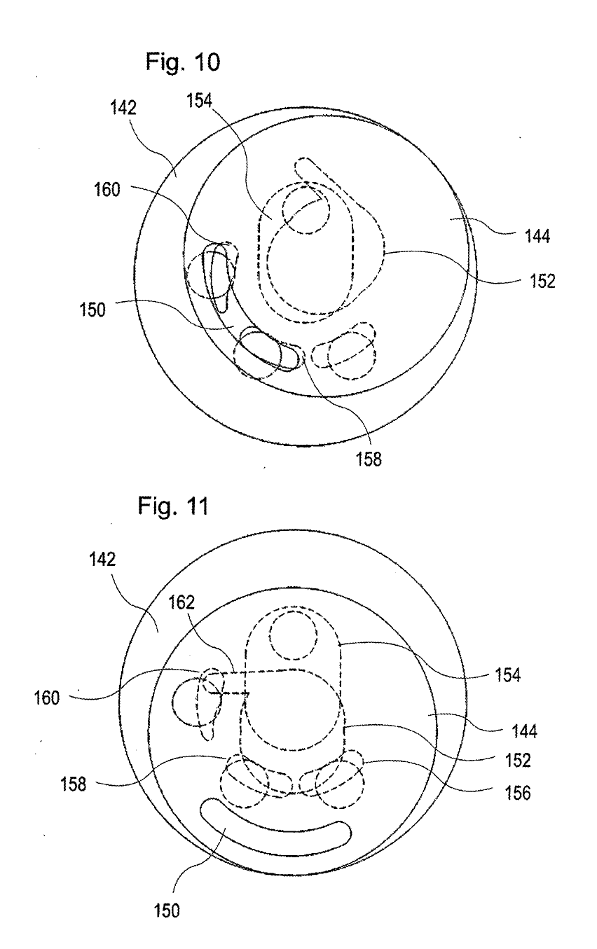

When the mixer in the closed position that corresponds to FIG. 2, the plunger is pushed back to the right under the effect of the spring until the stop comes into contact with the support 48 of the mobile disk 44. The balls are slid toward the inside of the plunger. By pushing the lever 40 downward, the support 48 of the mobile disk is moved to the right and the plunger is forced to retract into the support 48. The cold thermostatic element allows the piston to move to the left under the effect of the return spring, thus causing the balls to move outward in the groove of the support and therefore causing the locking of the plunger in the support. When hot water comes into contact with the thermostatic element, the expansion of the internal component thereof forces the rod and the piston back toward the right, against the effect of the return spring. The rightward movement of the piston allows the balls to slide toward the inside of the plunger, causing the unlocking of the plunger which, under the effect of the spring, pushes the support 48 back to the left into the position of closure of the mixer which corresponds to FIG. 2. The piston arranged vertically in the body of the tap, under the effect of its spring, causes a slight catching in order to clearly demarcate the various positions of the control. The device controlling the movement of the mobile disk which has just been described is described in greater detail in international patent application number PCT/EP2012/050850 filed on Jan. 20, 2012, notably in conjunction with FIGS. 10 to 13 and the description thereof. The content of that application, more particularly of the aforementioned passages and/or figures, is incorporated by reference.

FIG. 3 shows detail of the fixed distribution disk 42 and of the mobile distribution disk 44. The contacting faces seal the mixer. The fixed distribution disk 42 is provided with four through-orifices. The first orifice 56 is connected to the cold water inlet embodied by the circle in broken line 32 corresponding to the passage through the body of the mixing tap. The second orifice 58 is connected to the hot water inlet embodied by the circle in broken line 36 corresponding to the passage in the body of the mixer tap. The third orifice 60 is connected to the auxiliary water outlet embodied by the circle in broken line 34 corresponding to the passage in the body of the mixer tap. The fourth orifice 54 is connected to the service water outlet orifice 38 of the mixer tap.

The third orifice 60 is intended for removing the cold water initially contained in the hot-water pipe 22 (FIG. 1) and the warm water in this pipe that precedes the arrival of hot water.

The mobile disk 44 comprises the first cavity 50 in the form of a through-orifice communicating with a chamber of the support 48 (FIG. 2) comprising the thermostatic control means. The first cavity 50 is intended to place the incoming hot water 58 in communication with the auxiliary water outlet 60 when the control lever is turned to the left and pushed down in order to activate the hot-water preparation function. When the water flowing through the first cavity 50 in contact with the aforementioned thermostatic control means gradually increases in temperature, the thermostatic means react beyond a certain temperature when moving the mobile disk 44 in return toward a closed position without establishing interconnection between the incoming hot water 58 and the auxiliary water outlet 60.

The mobile distribution disk 44 comprises a second cavity 52 intended to place the first incoming cold water orifice 56 and/or the second, incoming hot water orifice 58 in communication with the service water outlet orifice 54 of the fixed disk 42 when the lever 40 is raised in the service position.

FIG. 4 shows a plan view from above of the two distribution disks in the closed position, with the control lever horizontal and in a central position. None of the orifices in the fixed disk is in communication with one of the other orifices of the disk.

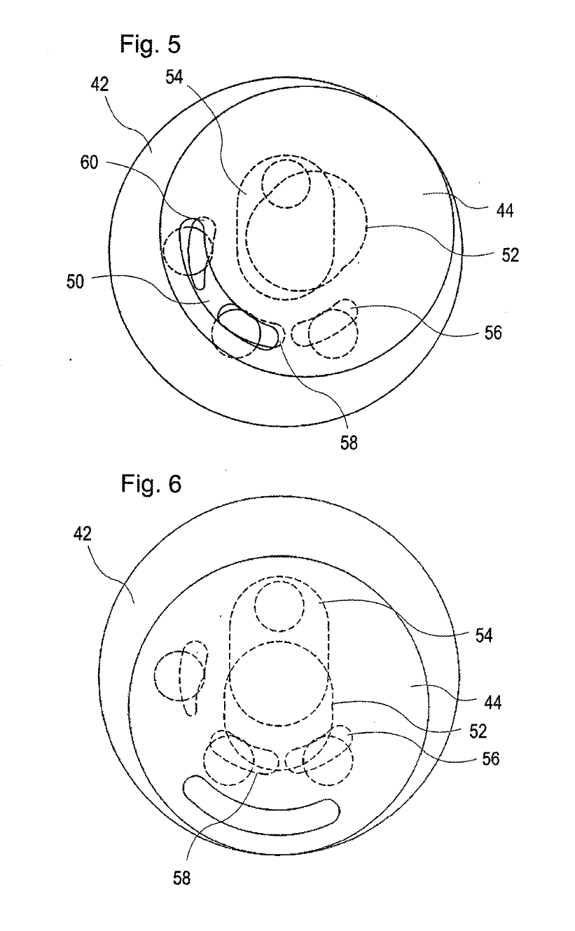

FIG. 5 shows a plan view from above of the two distribution disks when the control lever of the mixer is oriented fully to the left and pushed downward into the position corresponding to the hot-water preparation function. The incoming hot water orifice 58 is placed in communication with the auxiliary water outlet orifice 60 by the first cavity 50 and comes into contact with the thermostatic element in the support 48 (FIG. 2) of the mobile disk 44.

FIG. 6 shows a plan view from above of the two distribution disks when the control lever is lifted in a central position of interconnecting the first, second and fourth orifices 56, 58 and 52 respectively via the second cavity 52 in order to remove a mixture of hot water and cold water to the outlet.

Means of controlling the pump 18 can be provided for regularly transferring the water from the auxiliary pipe 24 to the hot-water pipe 22. More particularly, the transfer of water can be from the expansion vessel 16 to the hot-water pipe 22 and, more particularly still, to the expansion vessel 14.

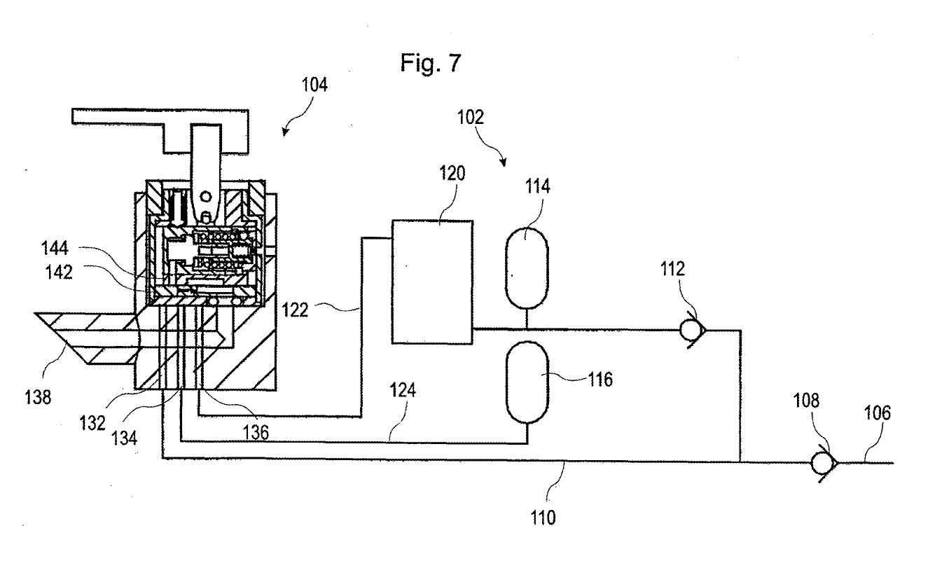

FIG. 7 shows an example of a diagram for the connection of the rapid-action water-saving mixer tap according to a second embodiment of the invention. The reference signs for the first embodiment are used in the second embodiment for the same elements or corresponding elements, although these signs are increased by 100 for the sake of clarity and in order to make a distinction between the embodiments. Specific reference signs are used for elements not present in the first embodiment, these signs being comprised between 100 and 199.

This second embodiment is intended for an existing sanitary installation in which it is difficult or expensive to add an auxiliary pipe for returning cooled water to the inlet of the water heating device. A source of cold water, such as a connection to the running-water mains network 106 in various embodiments passes via a nonreturn valve 108 to form the incoming cold-water 110 which is connected directly to a first orifice or first inlet 132 of the mixer tap 104. The incoming cold water 110 is connected, in various embodiments likewise via a nonreturn valve 112, to a water heating device 120. The incoming hot water 122 from the water heating device 120 is connected to a second orifice or second inlet 136 of the mixer 104. In a similar way to in the first embodiment of the invention, the mixer 104 comprises an auxiliary outlet 134 connected via an auxiliary pipe 124. However, unlike in the first embodiment, the auxiliary pipe does not comprise a pump for transferring its water. It comprises an expansion vessel 116 able to accumulate the cooled hot water while hot water is being prepared. In practice, the auxiliary pipe 124 can be very short and the expansion vessel 116 can be located at the most opportune location, such as, for example, under the sink to which the mixer 104 is fitted.

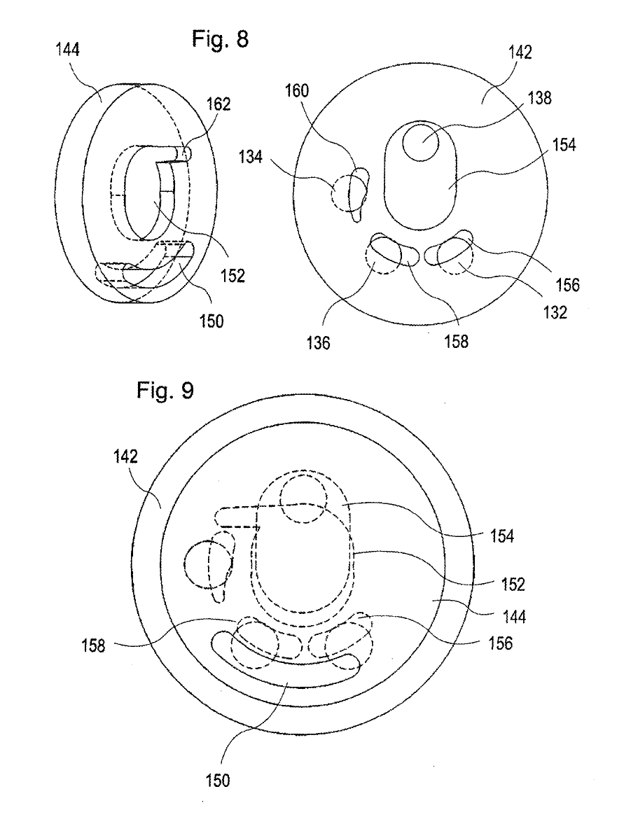

FIG. 8 shows detail of the fixed distribution disk 142 and of the mobile distribution disk 144. The contacting faces seal the mixer. The fixed distribution disk 142 is identical to that of the first embodiment (refer for example to FIG. 3). The mobile distribution disk 144 also comprises two cavities 150 and 152 like the mobile disk of the first embodiment (refer for example to FIG. 3). However, the second cavity 152 comprises an extension 162 that allows water from the auxiliary pipe 124, more particularly from the expansion vessel 116, to be removed to the service water outlet 138 when the lever of the mixer is in a raised central position corresponding to the opening of the mixer for mixing hot water with cold water.

FIG. 9 shows a plan view from above of the two distribution disks 142, 144 in the closed position, with the control lever horizontal and central. None of the orifices of the fixed disk is in communication with one of the others.

FIG. 10 shows a plan view from above of the two distribution disks when the control lever of the mixer is oriented fully to the left and pushed down into the position corresponding to the hot-water preparation function. The orifice 158 for incoming hot water is placed in communication with the auxiliary water outlet orifice 160 and comes into contact with the thermostatic element via the passage in the support of the mobile disk 144.

FIG. 11 shows a plan view from above of the two distribution disks when the control lever is lifted up in a central position for delivering a mixture of hot water and cold water to the service outlet. The extension or protrusion 162 of the cavity 152 is in communication with the rest of the cavity to allow the water contained in the expansion vessel 116 of the auxiliary pipe 124 to be discharged. In this position, the service water outlet orifice 154 is in communication with the incoming hot water orifice 158, with the incoming cold water orifice 156 and with the auxiliary outlet orifice 160.

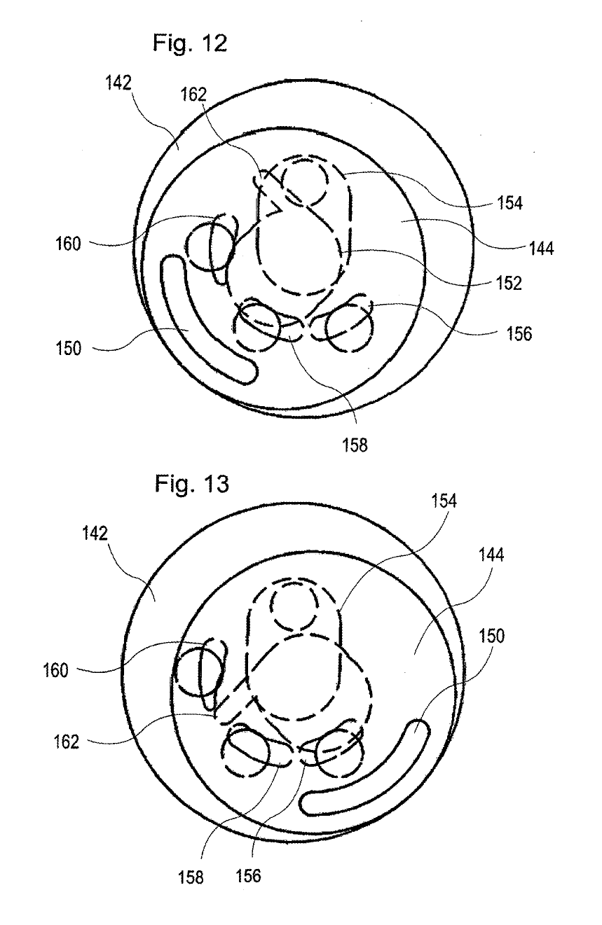

FIG. 12 is a plan view from above of the two distribution disks when the control lever is lifted in a position fully to the left for delivering exclusively hot water to the service outlet. It can be seen that the contour of the third orifice 160 is configured so as to allow the second cavity 152 of the mobile disk 144 to connect the second orifice 158 exclusively to the fourth orifice 154. The second cavity has a contour that is generally rounded and circular, and the contour of the third orifice 160 has a portion directed toward the center of the disk, which portion is inclined in such a way as to wrap around the corresponding portion of the profile of the second cavity.

FIG. 13 is a plan view from above of the two distribution disks when the control lever is lifted in a position fully to the right for a flow exclusively of cold water to the service outlet. It can be seen that the protrusion 162 of the second cavity 152 of the mobile disk 144 is configured so that it extends between the second and third orifices 158 and 160 respectively. The latter two orifices are spaced apart and the two disks are configured so that the protrusion covers neither the second nor the third orifice in the position for delivering exclusively cold water.

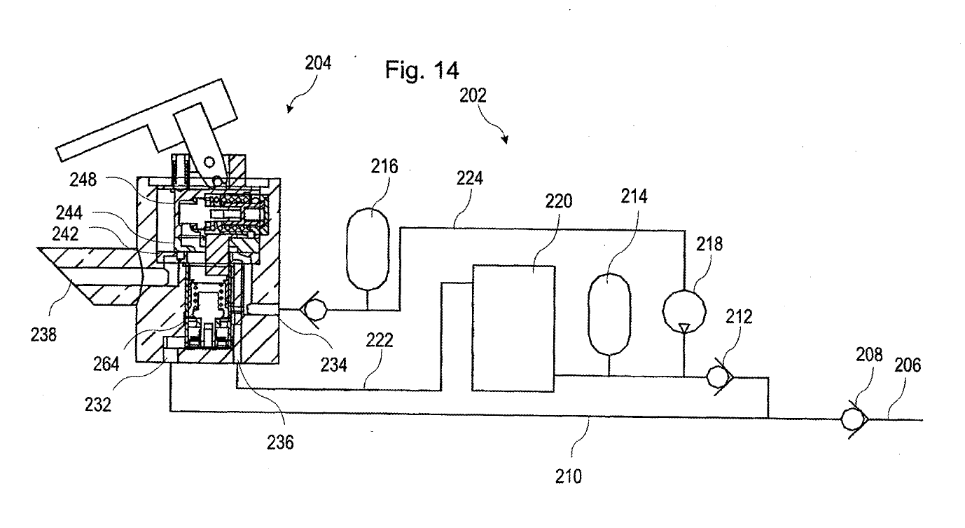

FIG. 14 is an example of a diagram for the connection of the rapid-acting water-saving mixer tap according to a third embodiment of the invention. The connection circuit is the same as in the first embodiment, the rapid-acting water-saving mixer tap however being of the thermostatic type. The thermostatic mixer is shown with the control lever lowered in the mode for the preparation of hot water.

The reference signs for the first embodiment are used in the third embodiment for the same elements or corresponding elements, although these signs are increased by 200 for the sake of clarity and in order to make a distinction between the embodiments. Specific reference signs are used for elements not present or different in the first embodiment, these signs being comprised between 200 and 299.

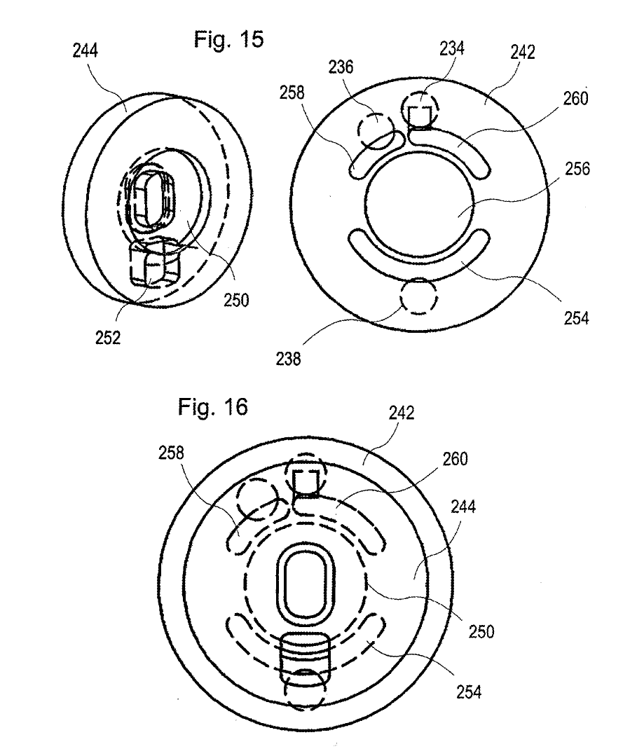

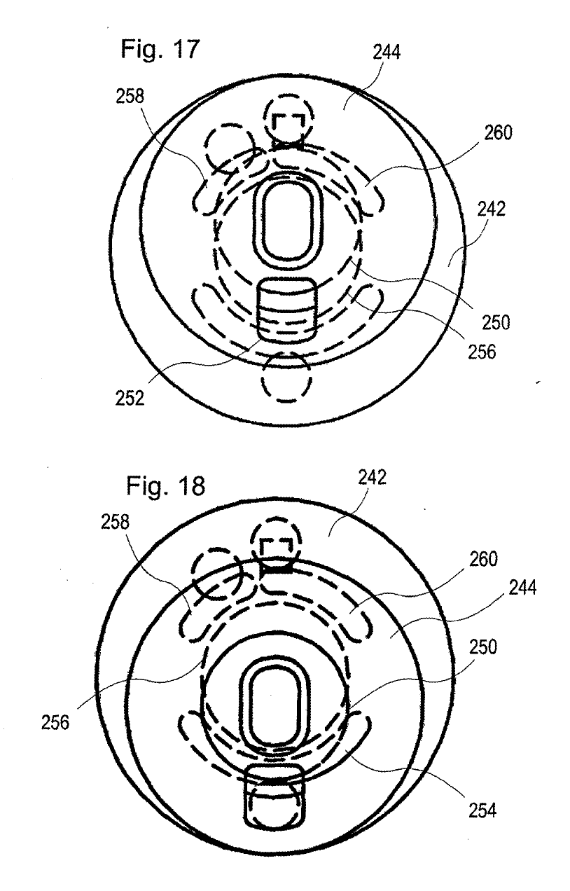

FIG. 15 shows detail of the fixed distribution disk 242 and of the mobile distribution disk 244. The contacting faces seal the mixer. The fixed distribution disk 242 comprises four through-orifices. The central first orifice 256 receives the mixed water, a mixture of cold water from the inlet 232 and hot water from the inlet 236 via the passages below and above the metering piston secured to the thermostatic element 264. The mobile distribution disk 244 comprises just a central cavity 250 which communicates with a cavity 252 of the support 248 of the mobile disk 244 to allow water to come into contact with the thermostatic element for the preparation of hot water. The thermostatic metering device 264 that has just been described is detailed further in international patent application number PCT/EP2012/050850 filed on Jan. 20, 2012, notably in conjunction with FIGS. 17 to 27 and the description thereof. The content of that application, more particularly of the aforementioned passages and/or figures, is incorporated by reference.

FIG. 16 shows a view from above of the two distribution disks in the closed position, with the control lever horizontal and central. None of the orifices in the fixed disk is placed in communication with one of the others.

FIG. 17 shows a plan view from above of the two distribution disks when the control lever of the mixer is pushed down into the position corresponding to the hot water preparation function. The incoming hot water orifice 258 and incoming warm water orifice 256 are placed in communication with the auxiliary water outlet orifice 260 and the water comes into contact with the hot water preparation thermostatic element via the passage 252 in the support 248 (FIG. 12) of the mobile disk 244.

FIG. 18 shows a plan view from above of the two distribution disks when the control lever is lifted in a central position for discharging mixed water coming from the orifice 256 and passing via the cavity 250 toward the outlet orifice 254.

In the description that has just been given of the various embodiments of the invention it should be noted that, for the sake of clarity of disclosure and illustration of the invention they have been described specifically for the preparation of hot water. It is important to note that this application is nonlimiting. Specifically, these embodiments could also be applied to the preparation of chilled water. In that case, the hot water inlet becomes a chilled water inlet. The cold water inlet can then potentially become a hot water inlet.

1.-20. (canceled)

21. A water-saving mixer tap, said tap comprising:
a first water inlet;
a second, thermally-conditioned water, inlet;
at least one service-water outlet for water coming from at least one of the first water inlet and the second, thermally-conditioned, water inlet;
an auxiliary water outlet;
a means of interconnection between the second, thermally conditioned, water inlet and the auxiliary outlet structured and operable to prepare conditioned water without loss of water via the service-water outlet; and
a flow regulating valve including the interconnection means.

22. The tap of claim 21, wherein the flow regulating valve is configured to meter the mixture of water from the first water inlet and the second, thermally conditioned, water inlet.

23. The tap of claim 22, wherein the flow regulating valve is configured to close the service outlet when it is in the position of interconnecting the second, thermally conditioned, water inlet with the auxiliary outlet.

24. The tap of claim 23, wherein the flow regulating valve comprises a fixed disk with a first orifice connected to the first water inlet, a second orifice connected to the second, thermally-conditioned, water inlet, a third orifice connected to the auxiliary outlet and a fourth orifice connected to the service outlet, and a mobile disk able to move against the fixed disk, with a first cavity able to cover at least partially and to interconnect the second and third orifices.

25. The tap of claim 24, wherein the first, second and third orifices of the fixed disk are arranged in that order along a curved profile.

26. The tap of claim 25, wherein the first cavity of the mobile disk comprises at least one orifice having a curved oblong shape able to collaborate with the second and third orifices of the fixed disk.

27. The tap of claim 26 further comprising a means preventing the mobile disk from adopting a position in which the first cavity covers the first orifice.

28. The tap of claim 27, wherein the mobile disk comprises a second cavity covering the fourth orifice and able selectively to cover at least partially and connect to it one of the first and the second orifice in a service position.

29. The tap of claim 28, wherein the portion of the second cavity of the mobile disk forms a protrusion from the generally rounded main part thereof.

30. The tap of claim 29, wherein the third orifice of the fixed disk and the second cavity of the mobile disk are configured so that the second cavity is not in communication with the third orifice when the mobile disk is in the position essentially of interconnecting the second and fourth orifices, the third orifice having a curved oblong contour of which the portion facing the contour of the fourth orifice is inclined in such a way as to reduce the width of the third orifice in the direction of the second orifice.

31. The tap of claim 30, wherein the first cavity of the mobile disk comprises means able to move the disk toward a position of stopping the interconnection of the second and third orifices when the temperature in the cavity reaches a threshold value.

32. The tap of claim 23 further comprising a thermostatic means of mixing water from the first and second water inlets with a mixed-water outlet and which are separate from the flow regulating valve, the valve comprising a fixed disk with a first orifice connected to the mixed-water outlet of the thermostatic means, a second orifice connected to the second water inlet, a third orifice connected to the auxiliary outlet and a fourth orifice connected to the service outlet, and a mobile disk able to move against the fixed disk, with a cavity able at least partially to cover and to interconnect the first, second and third orifices.

33. The tap of claim 32, wherein the first orifice of the fixed disk is in a central position of the disk with respect to the other orifices, the second and third orifices being on the opposite side of the first orifice to the fourth orifice.

34. The tap of claim 33, wherein the fourth orifice is of oblong shape in an arc of a circle centered on the first orifice.

35. The tap of claim 34, wherein at least one of the second and the third orifice is of oblong shape along an arc of a circle centered on the first orifice.

36. The tap of claim 35, wherein the cavity of the mobile disk comprises a means able to move the disk toward a position of stopping the interconnection of the second and third orifices when the temperature in the cavity reaches a threshold value.

37. The tap of claim 36, wherein the auxiliary outlet comprises a means of connection to a pipe situated on a portion of the tap that is intended to be hidden.

38. A running-water network, said network comprising:
a first water pipe,
a means of thermally conditioning the water forming a second water pipe,
a water mixing tap comprising:
a first water inlet connected to the first water pipe,
a second inlet connected to the second water pipe,
at least one service-water outlet for water coming from at least one of the first water inlet and the second, thermally-conditioned, water inlet;
an auxiliary water outlet;
a means of interconnection between the second, thermally conditioned, water inlet and the auxiliary outlet structured and operable to prepare conditioned water without loss of water via the service-water outlet; and
a flow regulating valve including the interconnection means, wherein the auxiliary outlet of the tap is connected to an auxiliary pipe provided with first storage means for storing water from the second water pipe which has lost its conditioning and is flowing toward the auxiliary pipe when the tap is in a position of preparing conditioned water.

39. The network of claim 38 further comprising a second water storage means and a nonreturn valve which are positioned between the conditioning means and the first water pipe, as well as a pump connecting the auxiliary pipe to the first water pipe between the second storage means and the nonreturn valve.

40. The network of claim 39, wherein the first storage means of the auxiliary pipe comprises a tank fitted with an elastic membrane.
